(19) United States
(12) Patent Application Publication
(10) Pub. No.: US 2012/0124431 A1
(43) Pub. Date: May 17, 2012

(54) METHOD AND SYSTEM FOR CLIENT RECOVERY STRATEGY IN A REDUNDANT SERVER CONFIGURATION

(75) Inventors: Eric Bauer, Freehold, NJ (US); Daniel W. Eustace, Naperville, IL (US); Randee Susan Adams, Naperville, IL (US)

(73) Assignee: Alcatel-Lucent USA Inc.

(21) Appl. No.: 12/948,493

(22) Filed: Nov. 17, 2010

(51) Int. Cl. G06F 11/16

(52) U.S. Cl. 714/55; 714/E11.067

(57) ABSTRACT

A method and system for client recovery strategy to maximize service availability for redundant configurations is provided. The technique includes adaptively adjusting timing parameter(s), detecting failures based on adaptively-adjusted timing parameter(s), and switching over to a redundant server. The timing parameter(s) include a maximum number of retries, response timers, and keepalive messages. Switching over to alternate servers engaged in warm sessions with the client may also be implemented to improve performance. The method and system allow for improved recovery time and suitable shaping of traffic to redundant servers.

### FIELD OF INVENTION

This invention relates to a method and system for client recovery strategy to improve service availability in a redundant server configuration in the network. While the invention is particularly directed to the art of client recovery strategy, and will be thus described with specific reference thereto, it will be appreciated that the invention may have usefulness in other fields and applications.

### BACKGROUND

The redundancy arrangement of a system is conveniently illustrated with a reliability block diagram (RBD), as in FIG. 1. As shown, a system 10 having components that are operational for service and arranged as a chain illustrate a redundancy configuration. A single component A is in series with a pair of redundant components B1 and B2, in series with another pair of redundant components C1 and C2, in series with a pool of redundant components D1, D2 and D3. The service offered by this sample system 10 is available through a path from the left edge of FIG. 1 to the right edge via components that are operational. To illustrate the advantage of a redundant system, for example, if component B1 fails, then traffic can be served by component B2, so the system can remain operational.

The objective of redundancy and high availability mechanisms is to assure that no single failure will produce an unacceptable service disruption. When a critical element is not configured with redundancy—such as component A in FIG. 1—a single point of failure may occur in such a simplex element and cause service to be unavailable until the failed simplex element can be repaired and service recovered. High availability and critical systems are typically designed so that no such single points of failure exist.

When a server fails, it is advantageous for the server to notify other components in the network of the failure. Accordingly, many functional failures are detected in a network because explicit error messages are transmitted by the failed component. For example, in FIG. 1, component B1 (e.g. a server) may fail and notify component A (e.g. another server or a client) of the failure through a standard-based error message. However, many critical failures prevent an explicit error response from reaching the client. Thus, many failures are detected implicitly—based on lack of acknowledgement of a message such as a command request or a keepalive. When the client sends such a request, the client typically starts a timer (called a response timer) and, if the timer expires before a response is received from the server, the client resends the request (called a retry) and restarts the response timer. If the timer expires again, the client continues to send retries until it reaches a maximum number of retries. Confirmation of the critical implicit failure, and hence initiation of any recovery action, is generally delayed by the initial response timeout plus the time to send the maximum number of unacknowledged retries.

Systems typically support both a response timer and retries, because these parameters are designed to detect different types of failures. The response timer detects server failures that prevent the server from processing requests. Retries protect against network failures that can occasionally cause packets to be lost. Reliable transport protocols, such as TCP and SCTP, support acknowledgements and retries. But, even when one of these is used, it is still desirable to use a response timer at the application layer to protect against failures of the application process. For example, an application session carried over a TCP connection might be up and properly sending packets and acknowledgements back and forth between the client and server, but the server-side application process might fail and, thus, be unable to correctly receive and send application payloads over the TCP connection to the client. In this case, the client would not be aware of the problem unless there is a separate acknowledgement message between the client and server applications.

Notably, many protocols (e.g., SIP) specify protocol timeouts and automatic protocol retry (having predetermined maximum retry counts). A logical strategy to improve service availability is for clients to retry to an alternate server when the maximum number of retransmissions has timed out. Note that clients can either be configured with network addresses (such as IP addresses) for both a primary and one or more alternate servers, or they can rely on DNS to provide the network addresses (e.g., via a round-robin scheme) or other mechanisms can be used. While this works very well for individual clients, this style of client driven recovery does not scale well for high availability services because a catastrophic failure of a server supporting a high number of clients can cause all of the client retransmissions and timeouts to be synchronized. Thus, all of the clients that were previously served by the failed server may suddenly attempt to connect/register to an alternate server, overloading the alternate server, and potentially cascading the failure to users who may have previously been served with acceptable quality of service by the alternate server (but the overload event causes their quality of service to be compromised).

A conventional strategy is to simply rely on the server overload control mechanism of the alternate server to shape the traffic and rely on the alternate server to remain operational, even in the face of a traffic spike or burst. In these situations, overload control strategies are typically designed to protect the server from collapse. Accordingly, these strategies are likely to be conservative and defer new connections for longer periods of time than may be necessary. More conservative strategies will deny client service for a longer time by deliberately slowing the new client connection or service to a predetermined rate. Eventually, the clients either successfully connect to an operational, alternative server or cease the process for connecting.

### SUMMARY

A method and system for client recovery strategy to maximize service availability in a redundant server configuration are provided.

In one aspect, the method comprises adaptively adjusting at least one timing parameter of a process to detect server failures, detecting the failures based on the at least one dynamically-adjusted timing parameter, and, switching over to a redundant server.

In another aspect, the at least one timing parameter is a maximum number of retries.

In another aspect, adaptively adjusting the at least one timing parameter comprises randomizing the maximum number of retries.

In another aspect, adaptively adjusting the at least one timing parameter comprises adjusting the maximum number of retries based on historical factors.

In another aspect, the at least one timing parameter comprises a response timer.

In another aspect, adaptively adjusting the at least one timing parameter comprises adjusting the response timer based on historical factors.

In another aspect, the at least one timing parameter comprises time periods between transmission of keepalive messages.

In another aspect, adaptively adjusting the at least one timing parameter comprises adjusting the time periods between the keepalive messages based on traffic load.

In another aspect, switching over to the redundant server comprises switching over to a redundant server maintaining a preconfigured session with a client.

In another aspect, the system comprises a control module to adaptively adjust at least one timing parameter of a process to detect server failures, detect the failures based on the at least one adaptively-adjusted timing parameter and switch over a client to a redundant server.

In another aspect, the at least one timing parameter is a maximum number of retries.

In another aspect, the control module adaptively adjusts the at least one timing parameter by randomizing the maximum number of retries.

In another aspect, the control module adaptively adjusts the at least one timing parameter by adjusting the maximum number of retries based on historical factors.

In another aspect, the at least one timing parameter comprises a response timer.

In another aspect, the control module adaptively adjusts the at least one timing parameter by adjusting the response timer based on historical factors.

In another aspect, the at least one timing parameter comprises time periods between transmission of keepalive messages.

In another aspect, the control module adaptively adjusts the at least one timing parameter by adjusting the time periods between the keepalive messages.

In another aspect, the redundant server is a redundant server in a preconfigured session with the client.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 is a sample reliability block diagram illustrating a redundant configuration.

FIG. 2 is an example system in which the presently described embodiments may be implemented.

FIG. 3 is a flow chart illustrating a method according to the presently described embodiments.

FIG. 4 is a timing diagram illustrating a failure technique.

FIG. 5 is a timing diagram illustrating a technique according to the presently described embodiments.

FIG. 6 is a timing diagram illustrating a technique according to the presently described embodiments.

FIG. 7 is a timing diagram illustrating a technique according to the presently described embodiments.

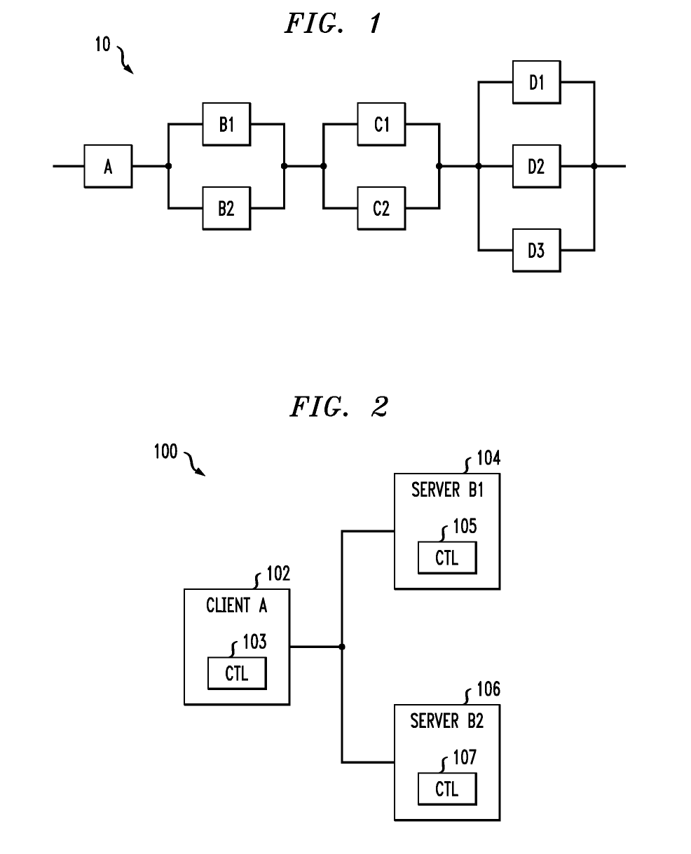

### DETAILED DESCRIPTION

The presently described embodiments may be applied to a network having a redundant deployment of servers to improve recovery time. With reference to FIG. 2, an example system 100, in which the presently described embodiments may be implemented, includes a logical client network element A (102) that is normally accessing a network service from server or network element B1 (104). A nominally geographically distributed, redundant server or network element B2 (106) (also referred to as an alternate or an alternate redundant server or network element) is also available in the network. It should be appreciated that such alternate servers or redundant servers or alternate redundant servers do not necessarily exactly replicate the primary server to which it corresponds. It should also be recognized that the configuration shown is merely an example. Variations may well be implemented. Also, it should be understood that more than one redundant or alternate network element may correspond to a primary network element (such as server B1).

The client A and servers B1 and B2 are also shown with a control module (103, 105 and 107, respectively) operative to control functionality of the network element on which it resides and/or other network elements. It should also be appreciated that the network elements may communicate using a variety of techniques, including standard protocols (e.g. SIP) via IP networking.

As will become apparent from a reading of detailed description below, implementation of the presently described embodiments facilitates improved service availability, as seen by client A, when server B1 fails.

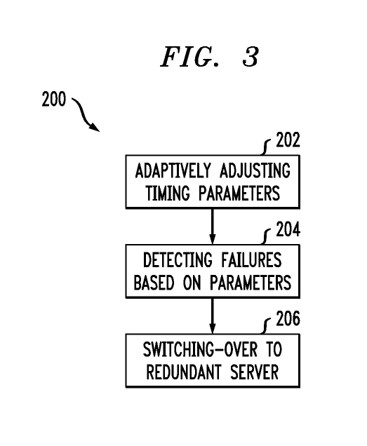

With reference to FIG. 3, a method 200 for client recovery strategy to improve service availability for redundant configurations is provided. The technique includes dynamically setting or adjusting timing parameters of the client process to detect server failures (at 202), detecting failures based on the dynamically-set timing parameters (at 204), and switching over to a redundant server (at 206).

It should be appreciated that the method 200 may be implemented using a variety of hardware configurations and software routines. For example, routines may reside on and/or be executed by the client A (e.g. by the control module 103 of client A) or the server B1 (or B2) (e.g. by the control modules 105, 107 of servers B1, B2). The routines may also be distributed on and/or executed by several or all of the illustrated system components to realize the presently described embodiments. Further, it should be appreciated that the terms “client” and “server” are referenced relative to a specific application protocol exchange. For example, a call server may be a “client” to a subscriber information database server, and a “server” to an IP telephone client. Still further, it should be appreciated that other network elements (not shown) may also be implemented to store and/or execute the routines implementing the method.

The subject timing parameters may vary from application to application, but include in at least one form:
MaxRetryCount—this parameter sets a maximum on the number of retries attempted after a response timer times out.
T_{TIMEOUT}—this parameter captures how quickly the client times out due to a profoundly non-responsive system, meaning the typical time for the initial request and all subsequent retries to timeout.
T_{KEEPALIVE}—this parameter captures how quickly a client polls a server to verify that the server is still available.
T_{CLIENT}—this parameter captures how quickly the typical (i.e., median or 50^{th} percentile) client successfully restores service on a redundant server.

According to the presently described embodiments, these values are adaptively (e.g. dynamically) set or adjusted, as described below. It is desirable to use small values for these parameters to detect failures and failover to an alternate server as quickly as possible, minimizing downtime and failed requests. However, it should be appreciated that failing over to an alternate server uses resources on that server to register the client and to retrieve the context information for that client. If too many clients failover simultaneously, an excessive number of registration attempts may drive the alternate server into overload. Therefore, it may be advantageous to avoid failovers for minor transient failures (such as blade failovers or temporarily slow processes due to a burst of traffic).

Accordingly, rather than simply having synchronized retransmission and timeout strategies cause traffic spikes or bursts to operational systems in the pool following failure of one system instance, shaping of reconnection requests to alternate servers is driven by the clients themselves. According to the presently described embodiments, the timing parameters are adapted and/or set so that implicit failure detection is optimized.

In one embodiment, the maximum number of retries is adjusted or set to a random number to improve client recovery. In this regard, while protocols specify (or negotiate) timeout periods and maximum retry counts, clients are not typically required to wait for the last retry to timeout before attempting to connect to an alternate server. Normally, the probability that a message will receive a reply prior to the protocol timeout expiration is very high (e.g., 99.999% service reliability). If the first message does not receive a reply prior to the protocol timeout expiration, then the probability that the first retransmission will yield a prompt and correct response is somewhat lower, and perhaps much lower. Each unacknowledged retransmission suggests a lower probability of success for the next retransmission.

According to the presently described embodiments, rather than simply waiting for each of these less likely or increasingly desperate retransmissions to succeed, clients can stop retransmitting to the non-responsive server based on different criteria, and/or switch-over to an alternate server at different times. If different clients register on the alternate server at different times, then the processing load for authentication, identification and session establishment of those clients is smoothed out so the alternate server is more likely to be able to accept those clients, thereby shortening the duration of service disruption. To accomplish this, clients, in this embodiment, randomize the number of retries that will be attempted—up to the maximum number of retransmission attempts negotiated in the protocol. Of course, randomized backoff such as the techniques proposed herein may not eliminate traffic spikes that may push an alternate server into an overload condition after major failure of a primary server; however, shaping the load by spreading client initiated recovery attempts over a longer time period will smooth the load on the alternate server.

An example strategy is for each client to execute the following procedure whenever a message or response timer times out:
1. Generate a random number or use a client unique number, e.g. specified digits of the network interface MAC address.
2. Logically divide the domain of random numbers into ‘MaximumRetryCount’ buckets.
3. Select the Maximum RetryCount value for this failed message (e.g. between 1 retries and MaximumRetryCount) based on the bucket into which the random number falls.

This is merely an example. The approach of randomizing can be realized in a variety of manners. For example, the approach can be weighted based on the cost of reconnecting to another server. For example, some services have larger amounts of state information that must be initialized, security credentials that must be validated, and other concerns that place a significant load on the system and increase delay in service delivery for the end user. To compensate for these higher cost reconnections for some protocols, the randomized maximum retry count can be adjusted either by excluding some retry options (e.g., always having at least one retry) or by weighting the options (e.g., exponentially weighting the maximum retry counts, such as how timeouts may be exponentially weighted). Note, the minimum number of the maximum retry count may be influenced by behavior of the underlying network and characteristics of the lower layer and transport protocols. A maximum retry count of—0—may be appropriate for some deployments, while a minimum number of the maximum retry count may be 1 for other deployments.

Further, in addition to simply setting a randomized maximum retry count that can be shorter than the standard maximum retry count used by the protocol, an additional randomized incremental backoff can be used to further shape traffic.

In another embodiment, the failure detection time is improved by collecting historical data on response times and number of retries necessary for a successful response. Thus, T_{TIMEOUT} and/or the maximum number of retries can be adaptively adjusted to more rapidly detect faults and trigger a recovery, as compared to the standard protocol timeout and retry strategy. It should be appreciated that collecting the data and adaptively adjusting the timing parameters may be accomplished using a variety of techniques. However, in at least one form, the data or response times and/or number of retries is tracked or maintained (e.g. by the client) for a predetermined period of time, e.g. on a daily basis. In such a scenario, the tracked data may be used to make the adaptive or dynamic adjustment. For example, it may be determined (e.g. by the client) that the adjusted value for the timer be set at a certain percentage (e.g. 60%) higher than the longest successful response time tracked for a given period, e.g. for the day and/or the previous day. In a variation, the values may be updated periodically, e.g. every 15 minutes, every 100 packets, . . . etc., to suit the needs of the network. This historical data may also be used to implement adjustments based on predictive behavior.

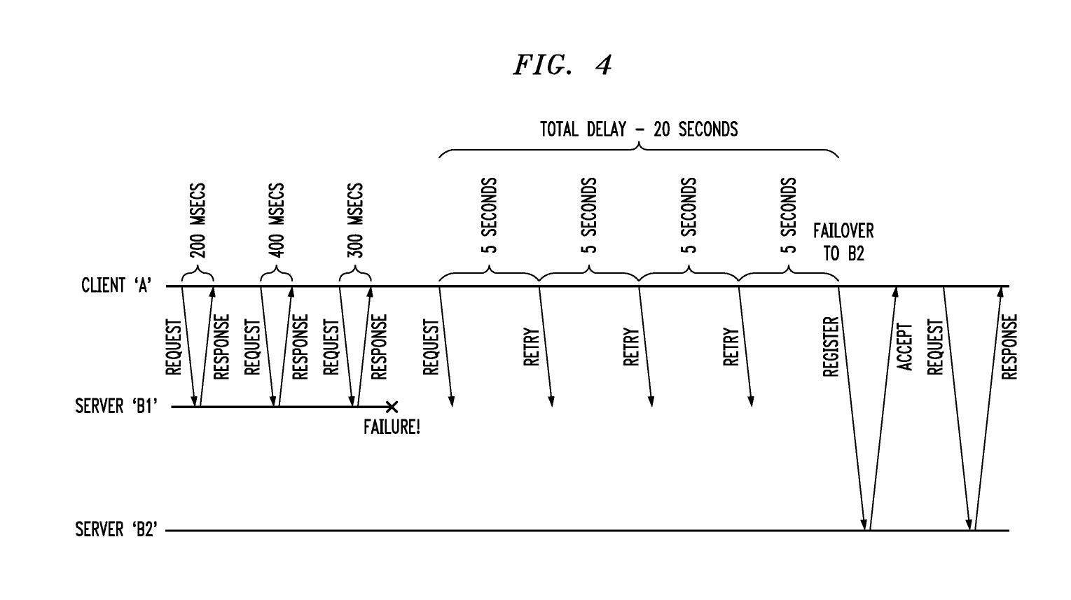

In a further example, with reference to FIG. 4, the protocol used between a client and server has a standard timeout of 5 seconds with a maximum of 3 retries. After the client A sends a request to the server 81, it will wait 5 seconds for a response. If the server 81 is down or unreachable and the timer expires, then the client A will send a retry and wait another 5 seconds. After retrying two more times and waiting 5 seconds after each retry, the client A will finally decide that the server B1 is down, after having spent a total of 20 seconds on waiting for a response to the initial message and subsequent retries. The client A then attempts to send the request to another server B2.

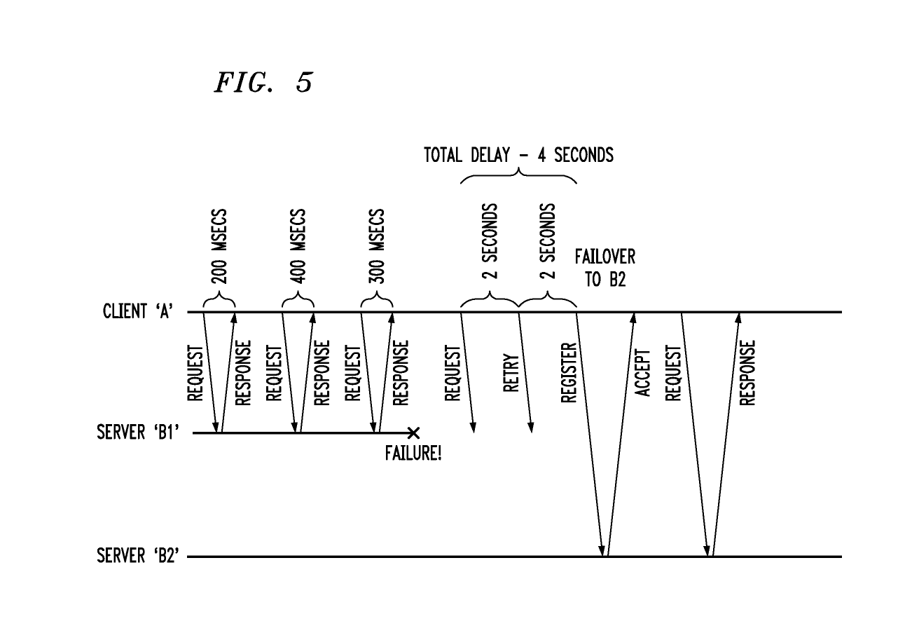

However, with reference to FIG. 5, and in accordance with the presently described embodiments, the client A can shorten the failure detection and recovery time. In this example, the client A keeps track of the response time of the server and measures the typical response time of the server to be between 200 and 400 ms. The client A could decrease its timer value from 5 seconds to, for example, 2 seconds (5 times the maximum observed response time) which has the benefit of contributing to a shorter recovery time using real observed behavior.

Furthermore, the client A may keep track of the number of retries it needs to send. If the server B1 frequently does not respond until the second or third retry, then the client should continue to follow the protocol standard of 3 retries. But, it may be that the server B1 always responds on the original request, so there is little value in sending any retries. If the client A decides that it can use a 2 second timer with only one retry, then it has decreased the total failover time from 20 seconds to 4 seconds, as illustrated in FIG. 5.

After failing over to a new server, in one form, the client A reverts to the standard or default protocol values for the registration, and continues using the standard values for requests—until it collects enough data on the new server to justify lower values.

As noted above, before lowering the protocol values too far, the processing time required to logon to the alternate server should be considered. If the client needs to establish an application session and get authenticated by the alternate server, then it becomes important to avoid bouncing back and forth between servers for minor interruptions (e.g. due to a simple blade failover, or due to a router failure that triggers an IP network reconfiguration). Therefore, in at least one form, a minimum timeout value is set and at least one retry is always attempted.

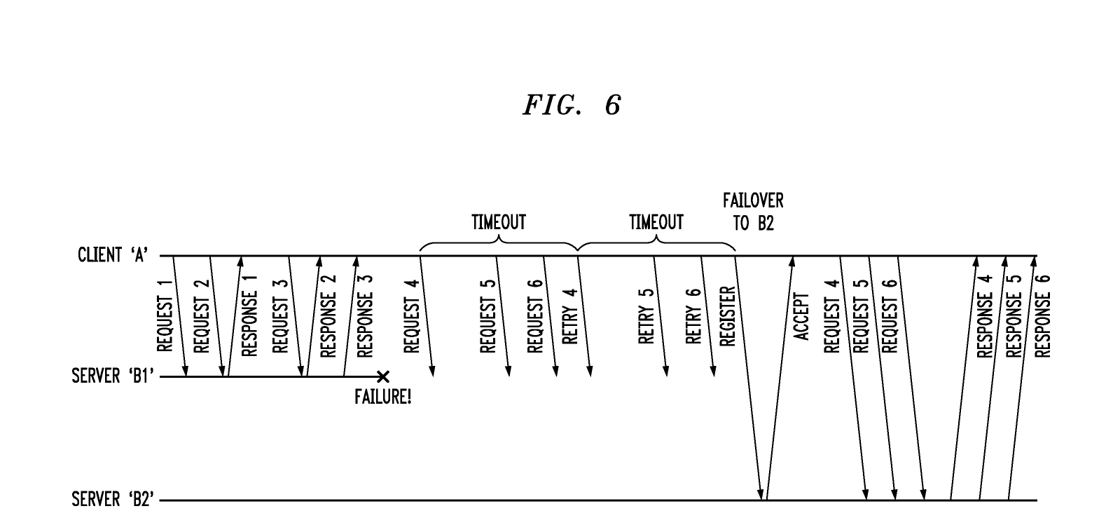

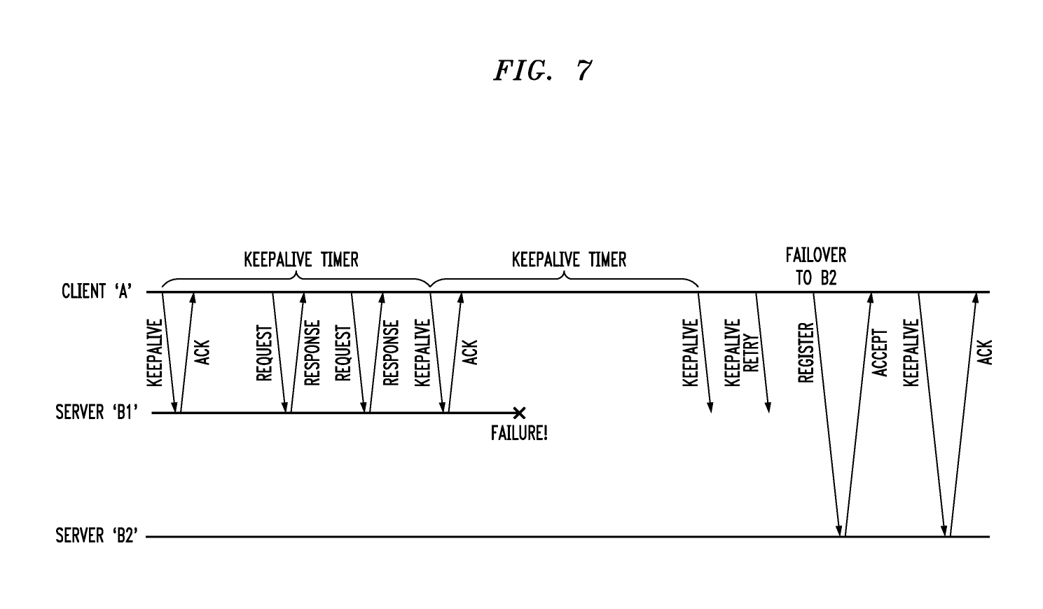

FIG. 6 illustrates another variation of the presently described embodiments. In this regard, it may be advantageous to correlate failure messages to determine whether there is a trend indicating a critical failure of the server and the need to choose an alternate server. This approach applies if the client A is sending many requests to the server B1 simultaneously. If the server B1 does not respond to one of the requests (or its retries), then it is no longer necessary to wait for a response on the other requests in progress—since those are likely to fail as well. The client A could immediately failover and direct all the current requests to an alternate server B2, and not send any more requests to the failed server B1 until it gets an indication that it has recovered (e.g. with a heartbeat). For example, as shown in FIG. 6, the client A can failover to the alternate server B2 when the retry for request 4 fails, and then it can immediately retry requests 5 and 6 to the alternate server. It does not wait until the retries for 5 and 6 timeout.

In the previous embodiments, the client A does not recognize that the server B1 is down until the server B1 fails to respond to a series of requests. This can negatively impact service in at least the following manners:
Reverse traffic interruption—Sometimes a client/server relationship works in both directions (for example, a cell phone can both initiate calls to mobile switching center and receive calls from it). If a server is down, it will not process requests from the client, and it will also not send any requests to the client. If the client does not have a need to send any requests to the server for a while then during this interval, requests towards the client will fail.
End user request failures—The request is delayed by T_{TIMEOUT}*(MaxRetryCount+1), which in some cases is long enough to cause the end user request to fail.

Thus, in another embodiment, a solution to this problem is to send a special heartbeat, called a keepalive message, to the server at specified times, and adjust the time between the sending of the keepalive messages based on, for example, an amount of traffic. Note that heartbeat messages and keepalive messages are similar mechanisms, but heartbeat messages are used between redundant servers and keepalive messages are used between a client and server. The time between keepalive messages is T_{KEEPALIVE}. Thus, according to the presently described embodiments, the value of T_{KEEPALIVE} can be adjusted based on the behavior of the server and the network, e.g. based on traffic load.

If the client A does not receive a response to a keepalive message from the server B1, then the client A can use the same timeout/retry algorithm as it uses for normal requests to determine if the server B1 has failed. The idea is that keepalive messages can detect server unavailability before an operational command would, so that service can automatically be recovered to an alternate server (e.g. B2) in time for real user requests to be promptly addressed by servers that are likely to be available. This is preferable to sending requests to servers when the client has no recent knowledge of the server ability to serve clients.

To illustrate the presently described embodiments, in FIG. 7, the client A sends a periodic keepalive message to the primary server B1 during periods of low traffic and expects to receive an acknowledgement. If the primary server B1 fails during this time, however, the client A will detect the failure by a failed keepalive message. In this regard, if the failed primary server does not respond to a keepalive or its retries, e.g. within the adjusted timeout value within the maximum number of retries, then the client A will failover to the alternate server B2. During periods of high traffic, while the client A is sending requests and receiving responses in the normal course, there is no need for a keepalive message. Note that in this case, no requests are ever delayed.

Of course, traffic load may be measured or predicted using a variety of techniques. For example, actual traffic flow may be measured. As one alternative, the time of day may be used to predict the traffic load.

A further enhancement is to restart the keepalive timer after every request/response, rather than after every keepalive. This will result in fewer keepalives during periods of higher traffic, while still ensuring that there are no long periods of inactivity with the server.

Another enhancement is for the client to send keepalive messages periodically to alternate servers also, and keeping track of their status. Then if the primary server fails, the client increase the probability of a rapid and successful recovery to a server which is more likely to be available than simply randomly selecting an alternate server.

In some forms, servers can also monitor the keepalive messages to check if the clients are still operational. If a server detects that it is no longer sending keepalive messages, or any other traffic, it could send a message to it in an attempt to wake it up, or at least report an alarm.

As with other parameters, T_{KEEPALIVE} should be set short enough to allow failures to be detected promptly but not so short that the server is using an excessive amount of resources processing keepalive messages from clients. The client can adapt the value of T_{KEEPALIVE} based on the behavior of the server and IP network.

T_{CLIENT} is the time need for a client to recover service on an alternate server. It includes the times for:
Client selecting an alternate server.
Negotiating a protocol with the alternate server.
Providing identification information.
Exchanging authentication credentials (perhaps bilaterally).
Checking authorization by the server.
Creating a session context on and by the server.
Creating appropriate audit messages by the server.

All of these factors consume time and resources of the target server, and perhaps other servers (e.g., AAA, user database servers, etc). Supporting user identification, authentication, authorization and access control often requires T_{CLIENT} to be increased.

In another variation of the presently described embodiments, T_{CLIENT} can be reduced by having the clients maintain a preconfigured or warm session with a redundant server. That is, when registered and obtaining service from their primary server (e.g. B1), clients A also connects and authenticates with another server (e.g. B2), so that if the primary server B1 fails, the client A can immediately begin sending requests to the other server B2.

If many clients attempt to log onto a server at once (e.g. after failure of a server or networking facility), and significant resources are needed to support registration, then an overload situation may occur. Of course, if the techniques of the presently described embodiments are used, the chances of overload on the alternate server will be greatly reduced.

Nonetheless, this possible overload may also be addressed in several other additional ways—which will not increase T_{CLIENT}:
Upon triggering the recovery to an alternate server the clients can wait a configurable period of time based on the number of clients served or amount of traffic being handled to reduce incidence of a flood of messages re-directed to backup system. The clients can wait a random amount of time before attempting to log onto the alternate server, but the mean time can be configurable, and set depending on the number of other clients that are likely to failover at the same time. If there are many other clients, then the mean time can be set to a higher value.
The alternate server should handle the registration storm as normal overload, throttling new session requests to avoid delivering unacceptable service quality to users who have already registered/connected to the alternate server. Some of the client requests will be rejected when they attempt to log onto the server. They should wait a random period of time before re-attempting.
When rejecting a registration request, the alternate server can proactively indicate to the client how long it should backoff (wait) before re-attempting to logon to the server. This gives the server control to spread the registration traffic as much as necessary
In a load-sharing case where there are several servers, the servers can update the weights in their DNS SRV records depending on how overloaded they are. When one server fails, its clients will do a DNS query to determine an alternate server, so most of them will migrate to the least busy servers.

A person of skill in the art would readily recognize that steps of various above-described methods can be performed by programmed computers (e.g. control modules 103, 105 or 107). Herein, some embodiments are also intended to cover program storage devices, e.g. digital data storage media, which are machine or computer readable and encode machine-executable or computer-executable programs of instructions, wherein said instructions perform some or all of the steps of said above-described methods. The program storage devices may be, e.g. digital memories, magnetic storage media such as a magnetic disks and magnetic tapes, hard drives, or optically readable digital data storage media. The embodiments are also intended to cover computers programmed to perform said steps of the above-described methods.

In addition, the functions of the various elements shown in the Figures, including any functional blocks labeled as clients or servers may be provided through the use of dedicated hardware as well as hardware capable of executing software in associated with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should also be appreciated that the presently described embodiments, including the method 200, may be used in various environments. For example, it should be recognized that the presently describe embodiments may be used with a variety of middleware arrangements, transport protocols, and physical networking protocols. Non-IP based networking may also be used.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for recovery in a system including clients operative to communicate with servers and corresponding redundant servers, the method comprising:
adaptively adjusting at least one timing parameter of a process to detect server failures;
detecting the failures based on the at least one adaptively-adjusted timing parameter; and,
switching over to a redundant server.

2. The method as set forth in claim 1 wherein the at least one timing parameter is a maximum number of retries.

3. The method as set forth in claim 2 wherein adaptively adjusting the at least one timing parameter comprises randomizing the maximum number of retries.

4. The method as set forth in claim 2 wherein adaptively adjusting the at least one timing parameter comprises adjusting the maximum number of retries based on historical factors.

5. The method as set forth in claim 1 wherein the at least one timing parameter comprises a response timer.

6. The method as set forth in claim 5 wherein adaptively adjusting the at least one timing parameter comprises adjusting the response timer based on historical factors.

7. The method as set forth in claim 1 wherein the at least one timing parameter comprises time periods between transmission of keepalive messages.

8. The method as set forth in claim 7 wherein adaptively adjusting the at least one timing parameter comprises adjusting the time periods between the keepalive messages based on traffic load.

9. The method as set forth in claim 1 wherein switching over to the redundant server comprises switching over to a redundant server maintaining a preconfigured session with a client.

10. A system for recovery in a network including clients operative to communicate with servers and corresponding redundant servers, the system comprising:
a control module to adaptively adjust at least one timing parameter of a process to detect server failures, detect the failures based on the at least one adaptively-adjusted timing parameter and switch over a client to a redundant server.

11. The system as set forth in claim 10 wherein the at least one timing parameter is a maximum number of retries.

12. The system as set forth in claim 11 wherein the control module adaptively adjusts the at least one timing parameter by randomizing the maximum number of retries.

13. The system as set forth in claim 11 wherein the control module adaptively adjusts the at least one timing parameter by adjusting the maximum number of retries based on historical factors.

14. The system as set forth in claim 10 wherein the at least one timing parameter comprises a response timer.

15. The system as set forth in claim 14 wherein the control module adaptively adjusts the at least one timing parameter by adjusting the response timer based on historical factors.

16. The system as set forth in claim 10 wherein the at least one timing parameter comprises time periods between transmission of keepalive messages.

17. The system as set forth in claim 16 wherein the control module adaptively adjusts the at least one timing parameter by adjusting the time periods between the keepalive messages based on traffic load.

18. The system as set forth in claim 1 wherein the redundant server is engaged in a preconfigured session with the client.
